(19) United States
(12) Patent Application Publication
(10) Pub. No.: US 2017/0058866 A1
(43) Pub. Date: Mar. 2, 2017

(54) THERMOPLASTIC PULTRUDED STIFFENERS FOR LOCALLY REINFORCING A WIND TURBINE ROTOR BLADE

(71) Applicant: General Electric Company, Schenectady, NY (US)

(72) Inventors: Christopher Daniel Caruso, Greenville, SC (US); Aaron A. Yarbrough, Greenville, SC (US); Daniel Alan Hynum, Simpsonville, SC (US)

(21) Appl. No.: 14/837,163

(22) Filed: Aug. 27, 2015

(51) Int. Cl. F03D 1/06; F03D 1/00

(52) U.S. Cl. CPC F03D 1/0675; F03D 1/001

(57) ABSTRACT

The present disclosure is directed to a rotor blade for a wind turbine having improved stiffness. The rotor blade includes a main blade structure, at least one thermoplastic blade segment configured with the main blade structure and defining the outer surface of the rotor blade, at least one spar cap configured at a first location on an internal surface of the at least one blade segment, and at least one pultruded stiffener configured at a second location on the internal surface of the at least one blade segment. Further, the pultruded stiffener is constructed, at least in part, from a thermoplastic resin system. Thus, the pultruded stiffener can be easily welding to the internal surface of the thermoplastic blade segment.

### FIELD OF THE INVENTION

The present disclosure relates generally to wind turbine rotor blades, and more particularly to thermoplastic pultruded stiffeners for locally reinforcing a wind turbine rotor blade.

### BACKGROUND OF THE INVENTION

Wind power is considered one of the cleanest, most environmentally friendly energy sources presently available, and wind turbines have gained increased attention in this regard. A modern wind turbine typically includes a tower, a generator, a gearbox, a nacelle, and a rotor having a rotatable hub with one or more rotor blades. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The rotor blades generally include a suction side shell and a pressure side shell typically formed using molding processes that are bonded together at bond lines along the leading and trailing edges of the blade. Further, the pressure and suction shells are relatively lightweight and have structural properties (e.g., stiffness, buckling resistance and strength) which are not configured to withstand the bending moments and other loads exerted on the rotor blade during operation. Thus, to increase the stiffness, buckling resistance and strength of the rotor blade, the body shell is typically reinforced using one or more opposing spar caps with a shear web configured therebetween that engage the inner pressure and suction side surfaces of the shell halves. The spar caps are typically constructed of glass fiber laminate composites and/or carbon fiber laminate composites. The shell of the rotor blade is generally built around the spar caps of the blade by stacking layers of fiber fabrics in a shell mold. The layers are then typically infused together, e.g. with a thermoset resin.

In some instances, additional structural support may be required for the rotor blade. Such support may be provided in the form of ribs, frames, and/or stringers that are typically constructed of thermoset resin composites. Thus, such structural components must be either co-infused into the blade shell during the infusion process or bonded to the blade shell post infusion. Either method, however, can be tedious and potentially expensive given the required surface treatment to effectively bond the components together.

Thus, the present disclosure is directed to thermoplastic pultruded structural components for a wind turbine rotor blade that are configured to locally reinforce the blade that address the aforementioned issues.

### BRIEF DESCRIPTION OF THE INVENTION

Aspects and advantages of the invention will be set forth in part in the following description, or may be obvious from the description, or may be learned through practice of the invention.

In one aspect, the present disclosure is directed to a rotor blade for a wind turbine having improved stiffness. The rotor blade includes a main blade structure, at least one blade segment configured with the main blade structure and defining an internal cavity of the rotor blade, at least one spar cap secured to an internal surface of the at least one blade segment, and at least one pultruded stiffener configured within the internal cavity of the at least one blade segment so as to provide additional stiffness to the rotor blade. In addition, the pultruded stiffener is constructed, at least in part, from a thermoplastic resin system.

In one embodiment, the blade segment(s) may also be constructed, at least in part, from a thermoplastic resin system. In such embodiments, the pultruded stiffener(s) may be easily welded to thermoplastic blade segment(s). In further embodiments, the thermoplastic resin system may also include at least one fiber reinforcement material, including but not limited to glass fibers, carbon fibers, polymer fibers, ceramic fibers, nanofibers, or metal fibers.

In another embodiment, the pultruded stiffener(s) may be secured to the internal surface of the blade segment(s), e.g. via welding. Alternatively, the pultruded stiffener(s) may be secured to the at least one spar cap, e.g. via welding. In additional embodiments, the rotor blade may include opposing spar caps configured on opposing internal surfaces of the blade segment(s) and one or more shear webs configured between the opposing spar caps. In such embodiments, the pultruded stiffener(s) may be secured to at least one of the opposing spar caps and/or the shear web.

In certain embodiments, the pultruded stiffener(s) may include a base portion and a stiffening portion. In such embodiments, the base portion may be welded to the internal surface of the blade segment(s). In addition, the stiffening portion may extend from the base portion within an internal cavity of the rotor blade so as to resist a load through a thickness of the at least one blade segment. For example, in certain embodiments, the load may include a buckling load, a flap-wise deflection, an edge-wise deflection, or similar.

In additional embodiments, the pultruded stiffener may extend in a generally span-wise direction within the internal cavity of the rotor blade when secured to an internal surface thereof. Further, in particular embodiments, the pultruded stiffener(s) may define a cross-section having one of the following shapes: triangle, rectangle, square, T-shaped, L-shaped, U-shaped, J-shaped, C-shaped, Z-shaped, V-shaped, or similar. Thus, the shape of the cross-section effectively locally reinforces the rotor blade, i.e. at the location of the stiffener.

In another aspect, the present disclosure is directed to a rotor blade for a wind turbine having improved stiffness. The rotor blade includes a blade root section, a blade tip section, a plurality of blade segments arranged between the blade root section and the blade tip section, opposing spar caps configured on opposing internal surfaces of the plurality of blade segments and extending in a generally span-wise direction, one or more shear webs configured between the opposing spar caps, and at least one pultruded stiffener. Further, each of the blade segments defines an internal cavity of the rotor blade and includes a thickness defined by an internal surface and an external surface thereof. Thus, the pultruded stiffener(s) are configured within the internal cavity of the rotor blade and are constructed, at least in part, from a thermoplastic resin system. As such, the pultruded stiffener can be easily welded to thermoplastic blade segments.

In yet another aspect, the present disclosure is directed to a method of improving stiffness of a rotor blade. The method includes providing a rotor blade having a main blade structure and at least one blade segment, the blade segment defining an internal cavity. The method also includes locally reinforcing one or more locations on the internal surface of the blade segment with one or more pultruded stiffeners. Further, the pultruded stiffener is constructed, at least in part, from a thermoplastic resin system. As such, the pultruded stiffener can be easily welded to thermoplastic blade segments.

In one embodiment, the method may also include securing opposing spar caps on opposing internal surfaces of the blade segment(s) and securing one or more shear webs between the opposing spar caps. Thus, the location(s) of local reinforcement may include at least one of an internal surface of the at least one blade segment, at least one of the opposing spar caps, the one or more shear webs, and/or any other suitable location within the internal cavity of the blade segment(s).

In further embodiments, the method may include forming the blade segment(s), at least in part, from a thermoplastic resin system and at least one fiber reinforcement material. In such embodiments, the pultruded stiffener(s) may be easily welded to the blade segment(s). More specifically, in additional embodiments, the step of locally reinforcing one or more locations on the internal surface of the blade segment with one or more pultruded stiffeners may include welding one or more pultruded stiffeners to the internal surface of the blade segment.

For example, in certain embodiments, the step of welding one or more pultruded stiffeners to the internal surface of the blade segment may include welding a base portion of the pultruded stiffener to the internal surface of the blade segment such that a stiffening portion of the pultruded stiffener extends from the base portion within an internal cavity of the rotor blade so as to resist a load acting through a thickness of the at least one blade segment. In addition, in another embodiment, the step of welding one or more pultruded stiffeners to the internal surface of the blade segment may include welding one or more of the pultruded stiffeners to the internal surface of the blade segment such that the stiffener extends in a generally span-wise direction within the internal cavity of the rotor blade.

In further embodiments, the method may also include forming the pultruded stiffener so as to define a cross-section comprising one of the following shapes: triangle, rectangle, square, T-shaped, L-shaped, U-shaped, J-shaped, C-shaped, Z-shaped, V-shaped, or similar.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a perspective view of one embodiment of a modular rotor blade of a wind turbine according to the present disclosure;

FIG. 3 illustrates an exploded view of the modular rotor blade of FIG. 2;

FIG. 4 illustrates a cross-sectional view of one embodiment of a leading edge segment of a modular rotor blade according to the present disclosure;

FIG. 5 illustrates a cross-sectional view of one embodiment of a trailing edge segment of a modular rotor blade according to the present disclosure;

FIG. 6 illustrates a cross-sectional view of the modular rotor blade of FIG. 2 according to the present disclosure along line 6-6, particularly illustrating a plurality of pultruded stiffeners configured within an internal cavity of the rotor blade;

FIG. 7 illustrates a cross-sectional view of the modular rotor blade of FIG. 2 according to the present disclosure along line 7-7, particularly illustrating a plurality of pultruded stiffeners configured within an internal cavity of the rotor blade;

FIG. 8 illustrates a cross-sectional view of another embodiment of a modular rotor blade according to the present disclosure, particularly illustrating a non-jointed, continuous blade segment having a plurality of pultruded stiffeners configured within an internal cavity thereof;

FIG. 9 illustrates a cross-sectional view of another embodiment of a modular rotor blade according to the present disclosure, particularly illustrating a single-jointed blade segment having a plurality of pultruded stiffeners configured within an internal cavity thereof;

FIG. 10 illustrates a cross-sectional view of another embodiment of a modular rotor blade according to the present disclosure, particularly illustrating a plurality of blade segments joined together via multiple joints and having a plurality of pultruded stiffeners configured within an internal cavity thereof;

FIG. 11 illustrates a cross-sectional view of another embodiment of a modular rotor blade according to the present disclosure, particularly illustrating a plurality of blade segments joined together via multiple joints and having a plurality of pultruded stiffeners configured within an internal cavity thereof;

FIG. 12 illustrates a cross-sectional view of one embodiment of a pultruded stiffener according to the present disclosure; and

FIG. 13 illustrates a flow diagram of one embodiment of a method for improving stiffness of a rotor blade according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a rotor blade for a wind turbine having improved stiffness. The rotor blade typically includes a blade root section, a blade tip section, and a plurality of thermoplastic blade segments arranged between the blade root section and the blade tip section. Thus, the blade segments define the outer surface of the rotor blade and an internal cavity therein. Further, the rotor blade may also include opposing spar caps secured to an internal surface of the blade segments and a shear web configure between the opposing spar caps. In addition, the rotor blade includes one or more pultruded stiffener configured within the internal cavity of the blade segments. Further, the pultruded stiffener is constructed, at least in part, from a thermoplastic resin system.

Thus, the present disclosure provides many advantages not present in the prior art. For example, in one embodiment, the present disclosure provides a rotor blade having thermoplastic blade segments and one or more thermoplastic pultruded stiffeners that can be easily welded to the internal surface of the blade segments. Accordingly, the rotor blades as described herein have improved stiffness and may reduce costs, labor time, and/or assembly cycle time of conventional rotor blade production. Further, the reinforced rotor blades of the present disclosure can have a reduced weight by eliminating many of the complex joints of conventional blades.

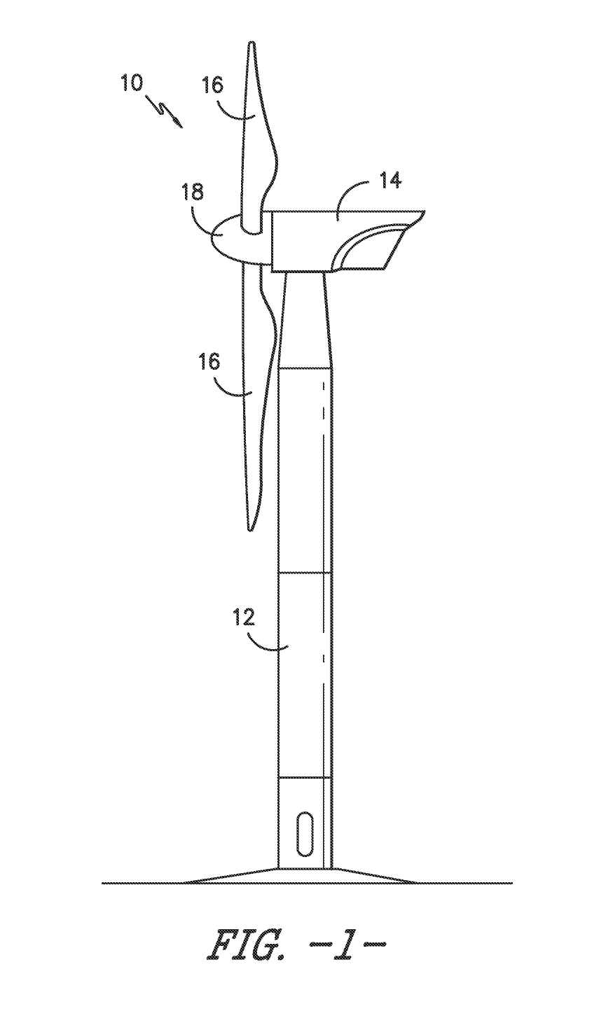

Referring now to the drawings, FIG. 1 illustrates one embodiment of a wind turbine 10 according to the present disclosure. As shown, the wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration. In addition, the present invention is not limited to use with wind turbines, but may be utilized in any application having rotor blades.

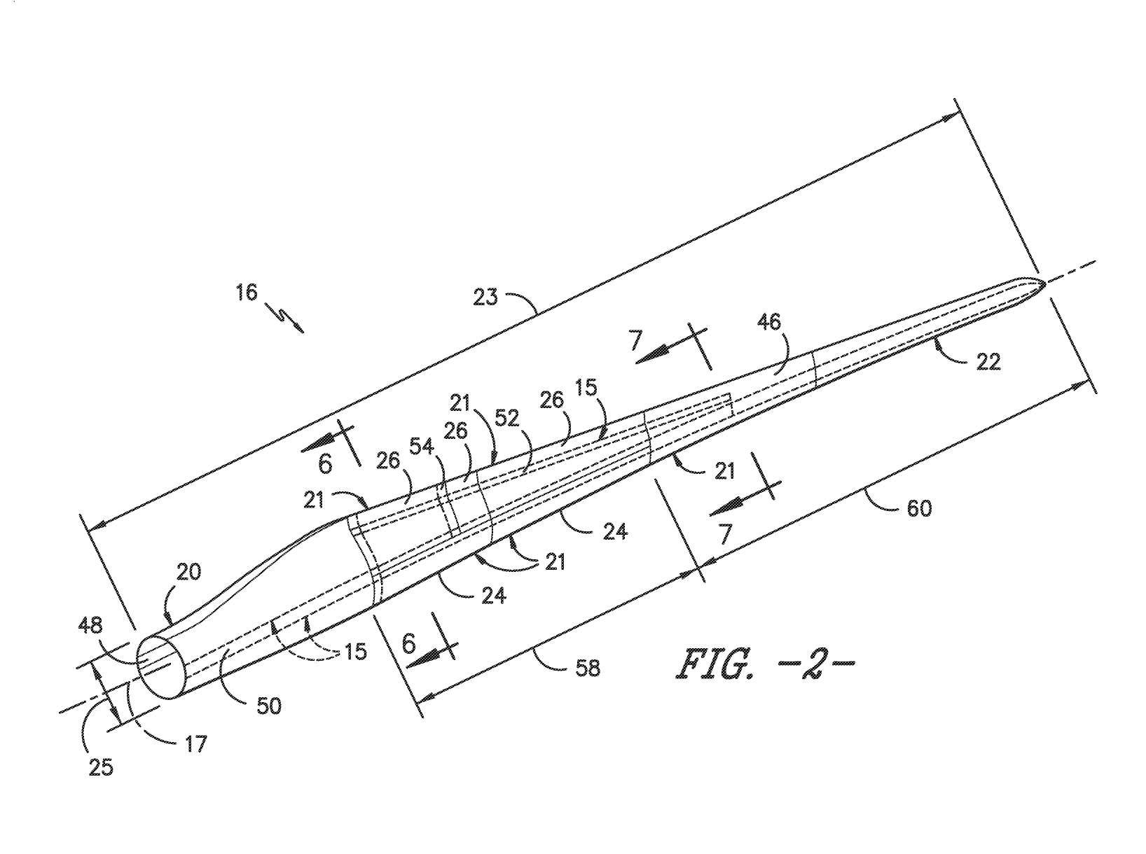

Referring now to FIGS. 2 and 3, various views of a rotor blade 16 according to the present disclosure are illustrated. As shown, the rotor blade 16 includes a main blade structure 15 constructed, at least in part, from a thermoset or a thermoplastic material and at least one blade segment 21 configured with the main blade structure 15. More specifically, as shown, the rotor blade 16 includes a plurality of blade segments 21. The blade segment(s) 21 may also be constructed, at least in part, from a thermoset material or a thermoplastic material. In addition, as mentioned, the thermoplastic and/or the thermoset materials as described herein may optionally be reinforced with a fiber material, including but not limited to glass fibers, carbon fibers, polymer fibers, ceramic fibers, nanofibers, metal fibers, or similar or combinations thereof. In addition, the direction of the fibers may include biaxial, unidirectional, triaxial, or any other another suitable direction and/or combinations thereof. Further, the fiber content may vary depending on the stiffness required in the corresponding blade component, the region or location of the blade component in the rotor blade 16, and/or the desired weldability of the component.

More specifically, as shown, the main blade structure 15 may include any one of or a combination of the following: a pre-formed blade root section 20, a pre-formed blade tip section 22, one or more one or more continuous spar caps 48, 50, 51, 53, one or more shear webs 35 (FIGS. 6-11), an additional structural component 52 (FIGS. 2-3) secured to the blade root section 20, and/or any other suitable structural component of the rotor blade 16. Further, the blade root section 20 is configured to be mounted or otherwise secured to the rotor 18 (FIG. 1). In addition, as shown in FIG. 2, the rotor blade 16 defines a span 23 that is equal to the total length between the blade root section 20 and the blade tip section 22. As shown in FIGS. 2 and 6, the rotor blade 16 also defines a chord 25 that is equal to the total length between a leading edge 40 of the rotor blade 16 and a trailing edge 42 of the rotor blade 16. As is generally understood, the chord 25 may generally vary in length with respect to the span 23 as the rotor blade 16 extends from the blade root section 20 to the blade tip section 22.

More specifically, in certain embodiments, as shown in FIGS. 2-3 and 6-7, the main blade structure 15 may include the blade root section 20 with one or more continuous, longitudinally extending spar caps 48, 50 infused therewith. For example, the blade root section 20 52 may be configured according to U.S. application Ser. No. 14/753,155 filed Jun. 29, 2015 entitled “Blade Root Section for a Modular Rotor Blade and Method of Manufacturing Same” which is incorporated herein by reference in its entirety. Similarly, the main blade structure 15 may include the blade tip section 22 with one or more longitudinally extending spar caps 51, 53 infused therewith. More specifically, as shown, the spar caps 48, 50, 51, 53 may be configured to be engaged against opposing internal surfaces 27, 29 of the blade segments 21 of the rotor blade 16. Further, the blade root spar caps 48, 50 may be configured to align with the blade tip spar caps 51, 53. Thus, the spar caps 48, 50, 51, 53 may generally be designed to control the bending stresses and/or other loads acting on the rotor blade 16 in a generally span-wise direction (a direction parallel to the span 23 of the rotor blade 16) during operation of a wind turbine 10. In addition, the spar caps 48, 50, 51, 53 may be designed to withstand the span-wise compression occurring during operation of the wind turbine 10. As such, the spar caps 48, 50, 51, 53 generally withstand the majority of the blade load and transfer the load to the hub 18 of the wind turbine 10. Further, the spar cap(s) 48, 50, 51, 53 may be configured to extend from the blade root section 20 to the blade tip section 22 or a portion thereof. Thus, in certain embodiments, the blade root section 20 and the blade tip section 22 may be joined together via their respective spar caps 48, 50, 51, 53.

In addition, the spar caps 48, 50, 51, 53 may be constructed of any suitable materials, e.g. a thermoplastic material, a thermoset material or combinations thereof. For example, in certain embodiments, one or more of the spar caps 48, 50, 51, 53 may be constructed of a low-cost resin material, e.g. a thermoset polymer, reinforced with one or more fiber materials. In such an embodiment, a thermoplastic resin (also optionally reinforced with a fiber material) may be infused around at least a portion of the already-cured thermoset spar caps. Thus, the thermoplastic resin system is configured to coat the spar cap so as to allow subsequent welding procedures to take place during assembly of the rotor blade 16 (e.g. to allow the thermoplastic blade segments 21 to be welded to one or more of the spar caps 48, 50, 51, 53). Further, the thermoplastic resin may encapsulate the entire spar cap or only certain regions of the spar cap to allow subsequent welding with other blade components. Moreover, such regions may be broken up by span or chord-wise directions and do not necessarily have to be continuous. In still additional embodiments, the spar caps 48, 50, 51, 53 may be constructed entirely of a thermoplastic material or entirely of a thermoset material. Further, in certain embodiments, the spar caps 48, 50, 51, 53 may be pultruded from thermoplastic or thermoset materials, which is discussed in more detail below.

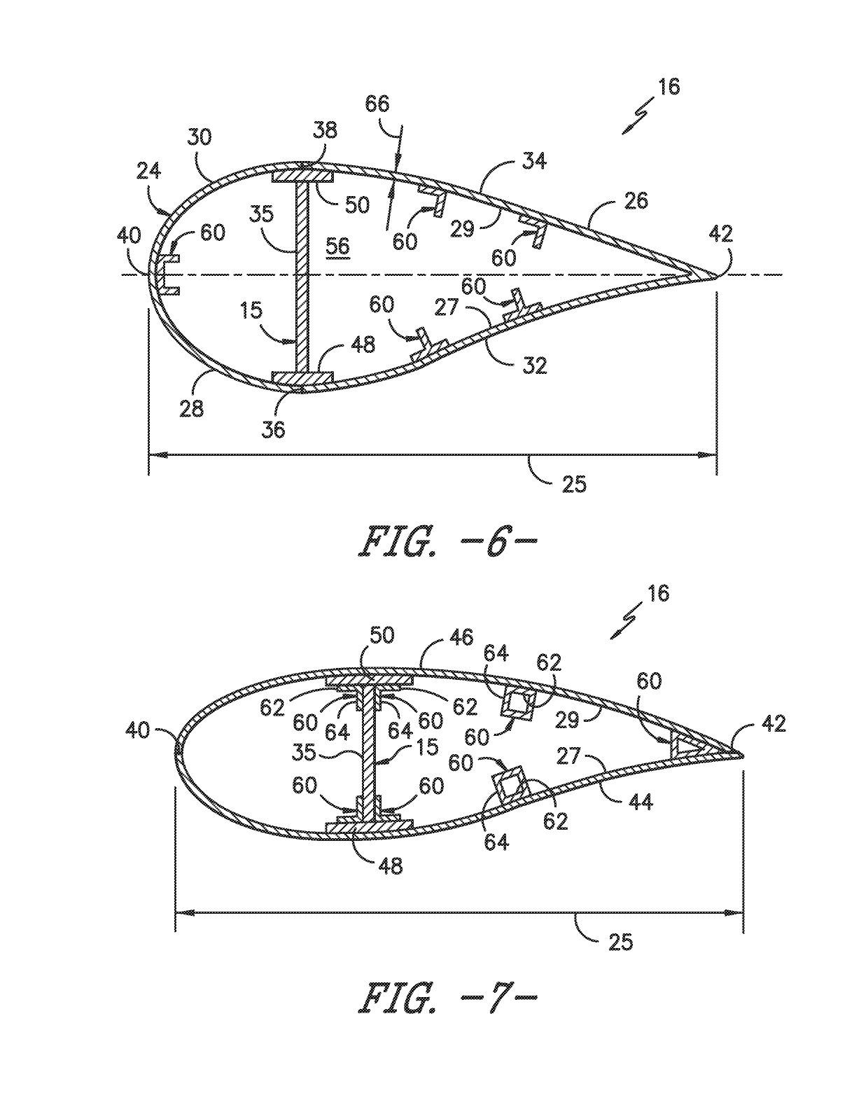

Further, as shown in FIGS. 6-7, the main blade structure 15 may include one or more shear webs 35 configured between the one or more spar caps 48, 50, 51, 53. More particularly, the shear web(s) 35 may be configured to increase the rigidity in the blade root section 20 and/or the blade tip section 22, for example, by transferring shear load between the spar caps 48, 50, 51, 53 and/or to prevent the rotor blade 16 from collapsing between the spar caps 48, 50, 51, 53. Further, the shear web(s) 35 may be configured to close out the blade root section 20.

In still additional embodiments, as shown in FIGS. 2 and 3, the main blade structure 15 may also include an additional structural component 52 secured to the blade root section 20 and extending in a generally span-wise direction. For example, the structural component 52 may be configured according to U.S. application Ser. No. 14/753,150 filed Jun. 29, 2015 entitled “Structural Component for a Modular Rotor Blade” which is incorporated herein by reference in its entirety. More specifically, the structural component 52 may extend any suitable distance between the blade root section 20 and the blade tip section 22 and may contact opposing internal surfaces of the blade segments 21. Thus, the structural component 52 is configured to provide additional structural support for the rotor blade 16 as well as an optional mounting structure for the various blade segments 21 as described herein. For example, in certain embodiments, the structural component 52 may be secured to the blade root section 20 and may extend a predetermined span-wise distance such that the leading and/or trailing edge segments 24, 26 can be mounted thereto.

Referring particularly to FIGS. 2-11, any number of blade segments 21 having any suitable size and/or shape may be generally arranged between the blade root section 20 and the blade tip section 22 along a longitudinal axis 17 in a generally span-wise direction. Thus, the blade segments 21 generally serve as the outer casing/covering of the rotor blade 16 and may define a substantially aerodynamic profile, such as by defining a symmetrical or cambered airfoil-shaped cross-section. In additional embodiments, it should be understood that the blade segment portion of the blade 16 may include any combination of the segments described herein and are not limited to the embodiment as depicted. Further, the blade segments 21 are arranged so as to define an internal cavity 56 of the rotor blade 16 having one or more internal surfaces 27, 29.

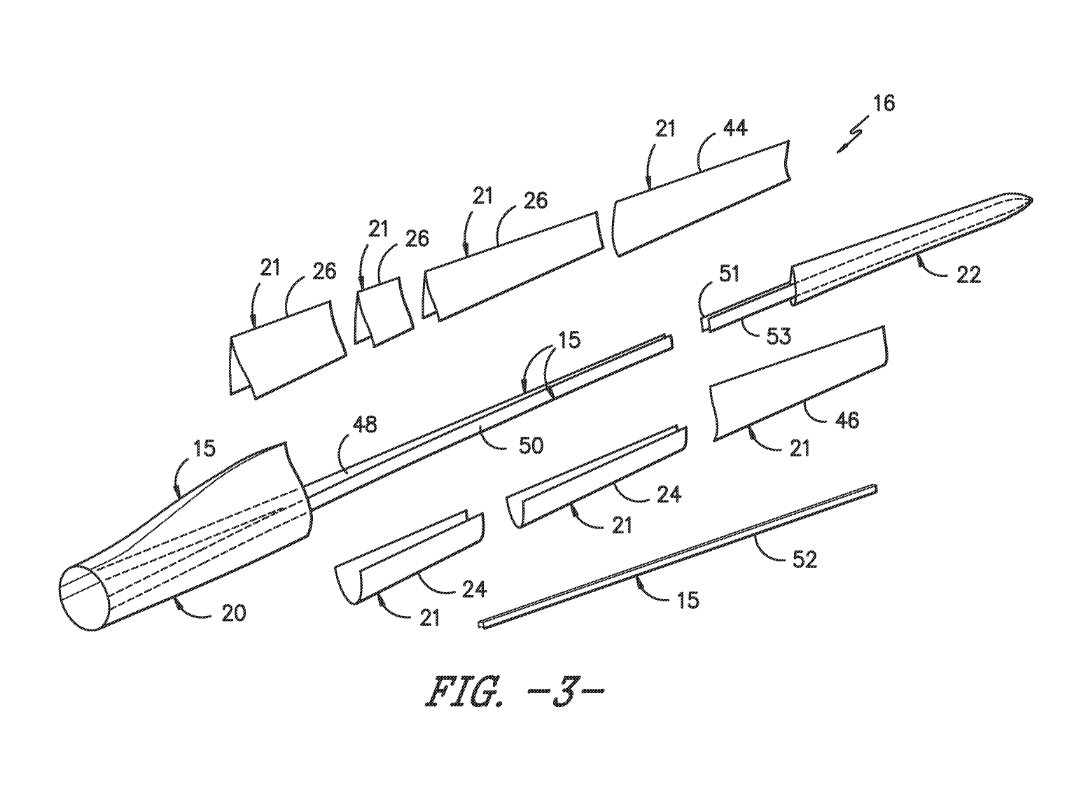

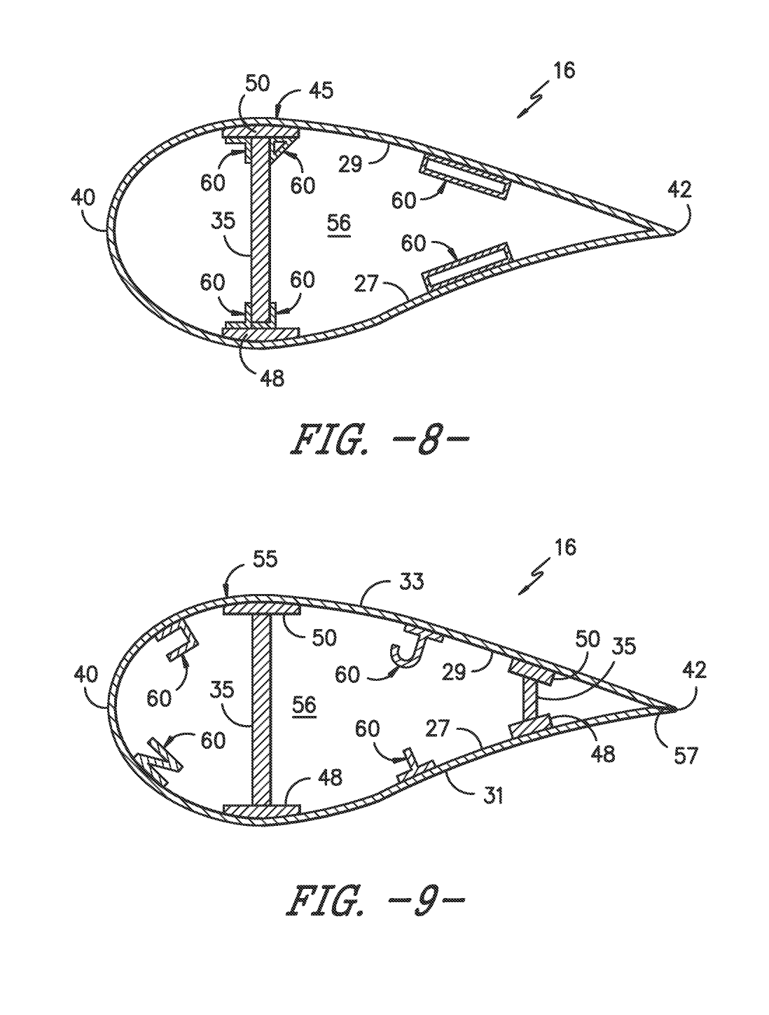

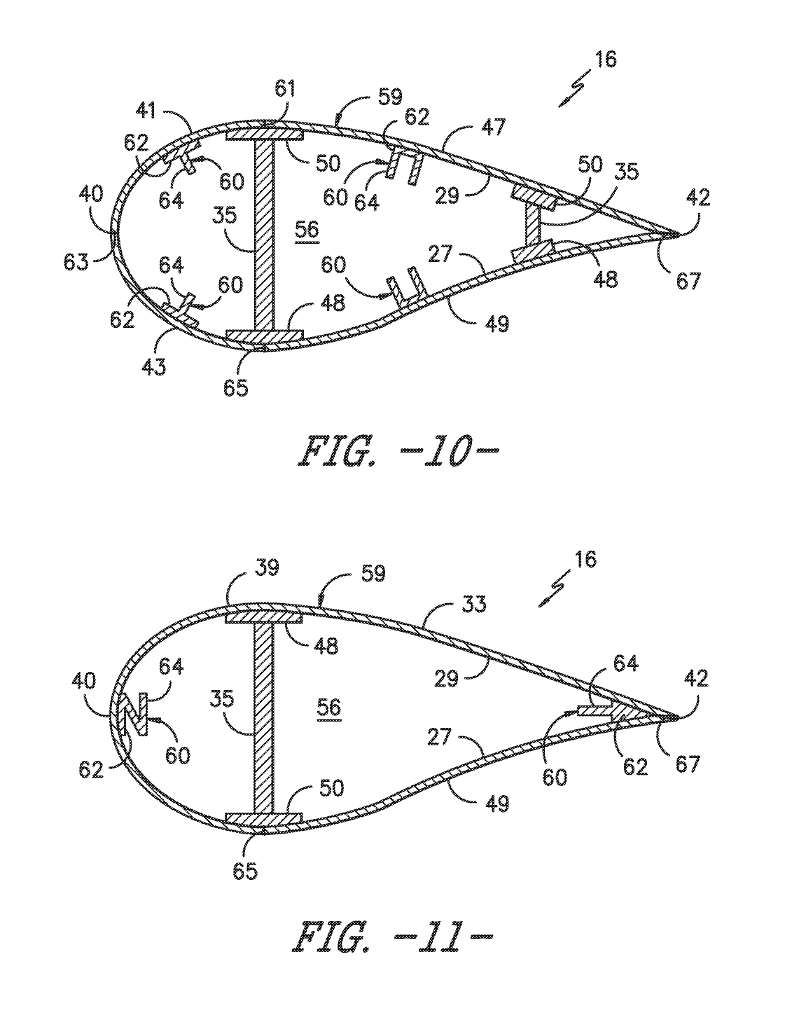

In addition, the blade segments 21 may be constructed of any suitable resin system, including but not limited to a thermoset material or a thermoplastic material, an optional fiber reinforcement material, and/or one or more additives. More specifically, as generally shown in the figures, the blade segments 21 may include any one of or combination of the following blade segments: pressure and/or suction side segments 44, 46, (FIG. 7), leading and/or trailing edge segments 24, 26 (FIGS. 4-6), a non-jointed segment 45 (FIG. 8), a single-jointed segment 55 (FIG. 9), a multi-jointed blade segment (FIG. 10), a J-shaped blade segment 59 (FIG. 11), or similar.

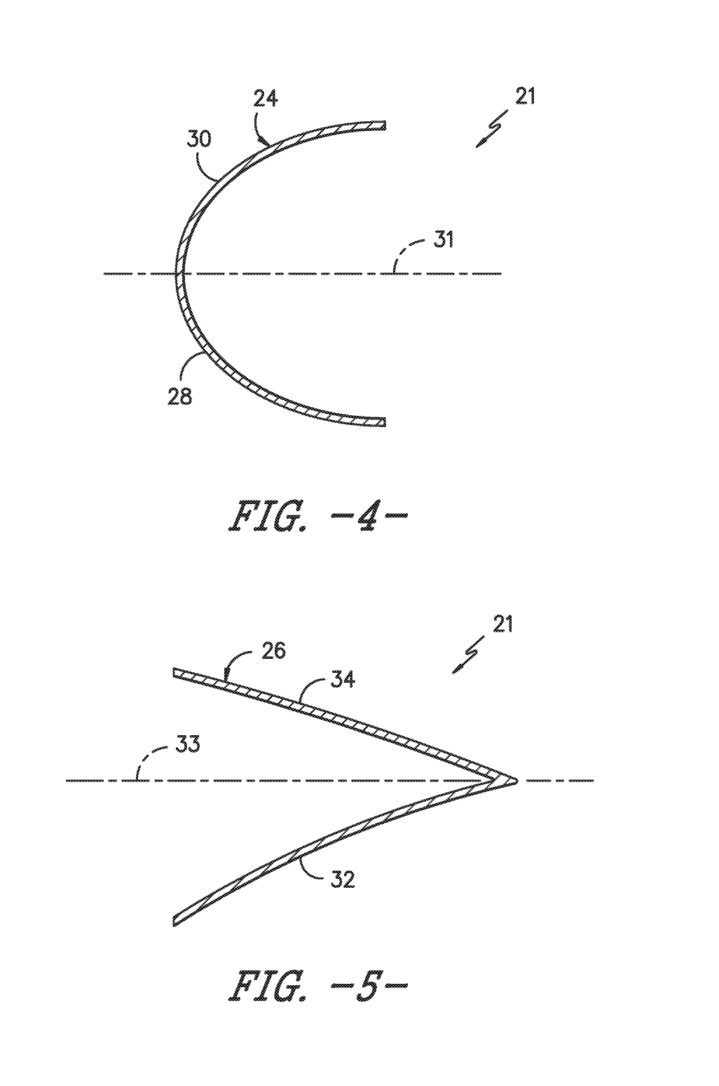

For example, as shown in FIG. 4, the leading edge segments 24 may have a forward pressure side surface 28 and a forward suction side surface 30. Similarly, as shown in FIG. 5, each of the trailing edge segments 26 may have an aft pressure side surface 32 and an aft suction side surface 34. Thus, the forward pressure side surface 28 of the leading edge segment 24 and the aft pressure side surface 32 of the trailing edge segment 26 generally define a pressure side surface of the rotor blade 16. Similarly, the forward suction side surface 30 of the leading edge segment 24 and the aft suction side surface 34 of the trailing edge segment 26 generally define a suction side surface of the rotor blade 16. In addition, as particularly shown in FIG. 6, the leading edge segment(s) 26 and the trailing edge segment(s) 26 may be joined at a pressure side seam 36 and a suction side seam 38. Further, as shown in FIG. 2, adjacent blade segments 24, 26 may be configured to overlap at a seam 54. Thus, where the blade segments are constructed of a thermoplastic material, adjacent blade segments 21 can be welded together along the seams 36, 38. Alternatively, in certain embodiments, the various segments of the rotor blade 16 may be secured together via an adhesive and/or one or more mechanical fasteners.

As shown in FIG. 8, the rotor blade 16 may also include a non-jointed, continuous blade surface 45, e.g. constructed at least in part of a thermoplastic material. Thus, as shown, the non-jointed, continuous blade surface 45 does not require bonding of multiple chord-wise segments. Alternatively, as shown in FIG. 9, the rotor blade 16 may also include a blade segment having a single-jointed blade surface 55. More specifically, as shown, the single-jointed blade surface 55 may include a pressure side surface 33, a suction side surface 31, and a single joint 57 at the trailing edge 42. Thus, the single-jointed blade surface 55 only requires one joint instead of multiple joints. Such blade segment(s) 21 can be easily mounted to the main blade structure 15, e.g. by separating the pressure and suction side surfaces 31, 33 at the single joint 57, mounting the continuous blade segment 55 over the one or more spar caps 48, 50, and securing the continuous blade segment 55 to the one or more spar caps 48, 58 between the blade root section 20 and the blade tip section 22, e.g. by welding the pressure and suction side surfaces 31, 33 at the single joint 57 and welding the blade segment 55 to the one or more spar caps 48, 50.

Moreover, as shown in FIGS. 10 and 11, the rotor blade 16 may also include a multi-jointed blade surface 59. More specifically, as shown in FIG. 10, the multi-jointed blade surface 59 may include a plurality of segments 41, 43, 47, 49 joined together via multiple joints 61, 63, 65, 67 spaced about the cross-section of the blade segment 59. For example, as shown, the segments 41, 43, 47, 49 may include a forward pressure side segment 43, a forward suction side segment 41, an aft pressure side segment 49, and an aft suction side segment 47. In another embodiment, as shown in FIG. 11, the blade segment 59 may include a generally J-shaped blade segment 39 and an additional blade segment, e.g. aft pressure side segment 49 or aft suction side segment 47, joined together via joints 65 and 67. More specifically, as shown, the J-shaped blade segment 39 may extend from the trailing edge 42 around the suction side surface 33 to a pressure side seam 35. In certain embodiments, such multi-jointed blade segments may be joined together, e.g. via welding, when the blade segments are constructed, at least in part, of a thermoplastic material.

The thermoplastic materials as described herein generally encompass a plastic material or polymer that is reversible in nature. For example, thermoplastic materials typically become pliable or moldable when heated to a certain temperature and returns to a more rigid state upon cooling. Further, thermoplastic materials may include amorphous thermoplastic materials and/or semi-crystalline thermoplastic materials. For example, some amorphous thermoplastic materials may generally include, but are not limited to, styrenes, vinyls, cellulosics, polyesters, acrylics, polysulphones, and/or imides. More specifically, exemplary amorphous thermoplastic materials may include polystyrene, acrylonitrile butadiene styrene (ABS), polymethyl methacrylate (PMMA), glycolised polyethylene terephthalate (PET-G), polycarbonate, polyvinyl acetate, amorphous polyamide, polyvinyl chlorides (PVC), polyvinylidene chloride, polyurethane, or any other suitable amorphous thermoplastic material. In addition, exemplary semi-crystalline thermoplastic materials may generally include, but are not limited to polyolefins, polyamides, fluropolymer, ethyl-methyl acrylate, polyesters, polycarbonates, and/or acetals. More specifically, exemplary semi-crystalline thermoplastic materials may include polybutylene terephthalate (PBT), polyethylene terephthalate (PET), polypropylene, polyphenyl sulfide, polyethylene, polyamide (nylon), polyetherketone, or any other suitable semi-crystalline thermoplastic material. Further, the thermoset materials as described herein generally encompass a plastic material or polymer that is non-reversible in nature. For example, thermoset materials, once cured, cannot be easily remolded or returned to a liquid state. As such, after initial forming, thermoset materials are generally resistant to heat, corrosion, and/or creep. Example thermoset materials may generally include, but are not limited to, some polyesters, some polyurethanes, esters, epoxies, or any other suitable thermoset material.

Referring now to FIGS. 6-11, the rotor blade 16 also includes at least one pultruded stiffener 60 configured within the internal cavity 56 of the rotor blade 16 so as to locally reinforce local regions of the rotor blade 16. For example, in certain embodiments, the pultruded stiffener(s) 60 may include ribs, frames, and/or stringers that serve as local reinforcement in regions of the blade that do not have spar caps, e.g. from the spar cap leading edge to the airfoil leading edge and from the spar cap trailing edge to the airfoil leading edge. In alternative embodiments, the pultruded stiffener(s) 60 may be configured with the spar caps 48, 50, 51, 53.

As used herein, the term “pultruded” or similar generally encompasses reinforced materials (e.g. fibers or woven or braided strands) that are impregnated with a resin (e.g. a thermoplastic polymer) and pulled through a stationary die such that the resin cures or undergoes polymerization. As such, the process of manufacturing pultruded components (e.g. such as the pultruded stiffeners 60) is typically characterized by a continuous process of composite materials that produces composite parts having a constant cross-section. In addition, the pultruded components may be produced from rovings, which generally encompass long and narrow bundles of fibers that are not combined until joined by a cured resin.

Thus, the pultruded stiffeners 60 as described herein may be constructed, at least in part, from a thermoplastic resin system. A thermoplastic resin system generally encompasses a thermoplastic material, optionally one or more fiber reinforcement materials, and/or one or more additives as necessary. In certain embodiments, the fiber reinforcement material may include glass fibers, carbon fibers, polymer fibers, ceramic fibers, nanofibers, metal fibers, or similar. Thus, in such embodiments, the pultruded stiffener(s) 60 may be easily welded to the thermoplastic blade segment(s) 21 and/or various other components within the internal cavity 56 of the rotor blade 16. In addition, the pultruded stiffener 60 may generally extend in a generally span-wise direction within the internal cavity 56 of the rotor blade 16 when secured therein.

For example, as shown in FIGS. 6-11, each of the illustrated rotor blades 16 includes one or more pultruded stiffeners 60 secured (e.g. via welding) to one or more of the internal surfaces 27, 29 of the blade segment(s) 21. In addition, as shown in FIGS. 7 and 8, the rotor blade 16 may include one or more pultruded components 60 configured with the spar caps 48, 50 and/or the shear webs 35 of the rotor blade. More specifically, as shown, the pultruded stiffener(s) 60 may be configured at an interface between the spar caps 48, 50 and the shear web 35. For example, as shown in FIG. 7, a plurality of L-shaped pultruded stiffeners 60 are configured at the corners defined by the opposing interfaces between the spar caps 48, 50 and the shear web 35. Alternatively, as shown in FIG. 8, the opposing interfaces between the spar caps 48, 50 and the shear web 35 include a plurality of L-shaped pultruded stiffeners 60 as well as a triangular-shaped pultruded stiffener 60. Further, as shown, the pultruded stiffeners 60 may be configured between the spar caps 48, 50 and shear web (FIG. 8) or adjacent to the spar caps 48, 50 and shear web 35 (FIGS. 7 and 8). Thus, such pultruded stiffeners 60 are configured to provide additional support to the interface of the spar caps 48, 50 and shear web 35.

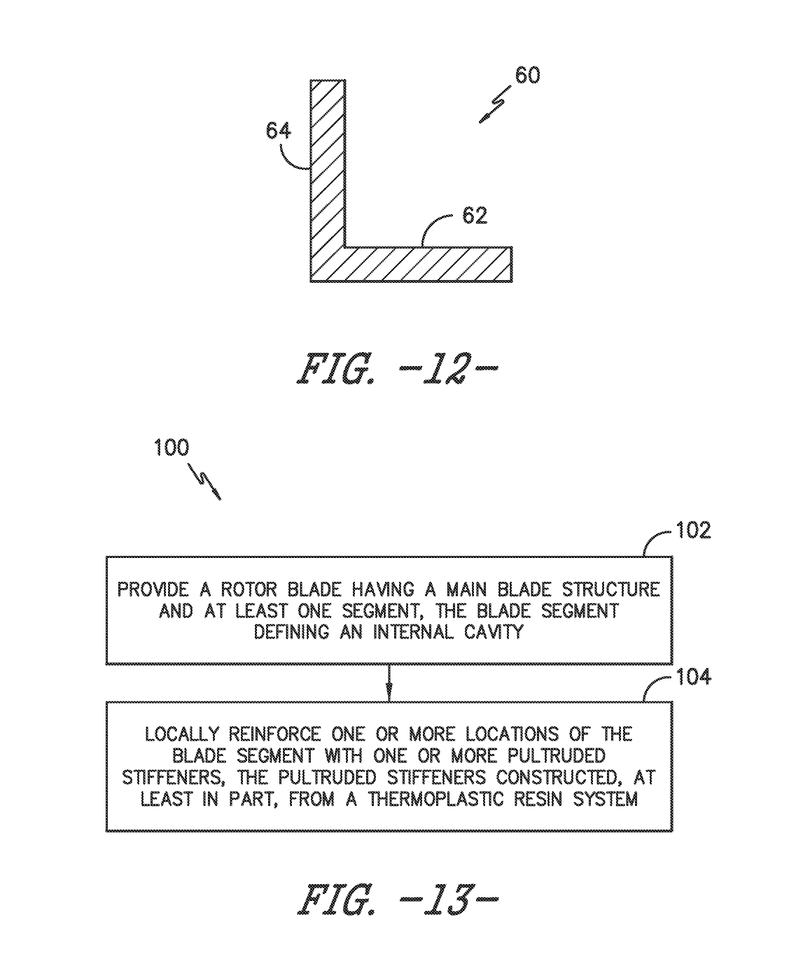

Further, as shown particularly in FIGS. 7 and 10-12, the pultruded stiffener(s) 60 may include a base portion 62 and a stiffening portion 64. In such embodiments, as generally shown in the figures, the base portion 62 may be secured to one of the internal surfaces 27, 29 of the blade segment(s) 21, e.g. via welding. More specifically, as shown, the base portion 62 of the pultruded stiffener 60 may be secured to any suitable location within the internal cavity 56. For example, as mentioned, the base portion 62 of the pultruded stiffener 60 may be secured at any location that does not include spar caps so as to provide local reinforcement to regions that would otherwise be unsupported. More specifically, in embodiments having blade segments 21 constructed of a thermoplastic resin system, the base portion 62 of the pultruded stiffener 60 may be easily welded thereto. Alternatively, as shown in FIG. 7, the base portion 62 may be secured (e.g. via welding) to the spar caps 48, 50 and/or the shear web 35. Thus, as shown, the stiffening portion 64 may extend from the base portion 62 within the internal cavity 56 of the rotor blade 16 so as to resist a load through a thickness 66 of the blade segment 21. For example, as shown, the pultruded stiffener(s) 60 may extend within the internal cavity 56 from a first internal surface towards an opposing internal surface without contacting the opposing internal surface. Alternatively, the pultruded stiffener(s) 60 may extend within the internal cavity 56 from a first internal surface to an opposing internal surface such that the stiffener 60 contacts opposing internal surfaces 27, 29.

Further, the loads as described herein may include a buckling load, a flap-wise deflection, an edge-wise deflection, or any other similar load acting on the rotor blade 16. More specifically, the stiffening portion 64, which generally defines the shape of the stiffener 60, typically generates the stiffness for a buckling load through the blade skin, as well as, most of the stiffness to resist flap-wise deflection of the blade 16. Thus, the shape of the pultruded stiffener 60 may be chosen based on the moment of inertia of the shape and/or the direction of the load being resisted. More specifically, the shape of the stiffening portion 64 may include a shape that extends generally perpendicular to the internal surfaces 27, 29. Alternatively, the shape of the stiffening portion 64 may be angled relative to the internal surfaces 27, 29, e.g. at a 45-degree angle. In addition, the shape of the stiffening portion 64 may be curved. Accordingly, the pultruded stiffener(s) 60 may define any suitable cross-sectional shape, including but not limited to the following: a triangle, a rectangle, a square, T-shaped, L-shaped, U-shaped, J-shaped, C-shaped, Z-shaped, V-shaped, or similar. Thus, the cross-sectional shape of the pultruded stiffener(s) 60 may include an open cross-section or a closed cross-section. Further, in certain embodiments, the cross-sectional shape may include a solid cross-section (FIGS. 6 and 11) and/or a hollow cross-section (FIGS. 7 and 8).

Referring now to FIG. 13, a flow diagram of one embodiment of a method of improving stiffness of a rotor blade 16 according to the present disclosure is illustrated. As shown at 102, the method 100 includes providing a rotor blade 16 having a main blade structure 15 and at least one blade segment 21. Further, the blade segment 21 defines an internal cavity 56. More specifically, in further embodiments, the method 100 may include forming the at least one blade segment 21, at least in part, from a thermoplastic resin system and at least one fiber reinforcement material. The method 100 may also optionally include securing at least one spar cap at a first location on an internal surface 29 of the blade segment 21. In another embodiment, the method 100 may also include securing opposing spar caps 48, 50 on opposing internal surfaces 27, 29 of the blade segment(s) 21 and securing one or more shear webs 35 between the opposing spar caps 48, 50.

As shown at 104, the method 100 also includes locally reinforcing one or more locations on one or more of the internal surfaces 27, 29 of the blade segment(s) 21 with one or more pultruded stiffeners 60. In certain embodiments, for example, the location(s) may include one or more of the internal surfaces 27, 29 of the blade segment(s) 21, one or more of the opposing spar caps 48, 50, and/or the shear web(s) 35. Thus, in certain embodiments, the pultruded stiffener(s) 60 may be easily welded to the thermoplastic blade segment(s) 21. More specifically, in additional embodiments, the step of locally reinforcing one or more additional locations on one or more of the internal surfaces 27, 29 of the blade segment(s) 21 with one or more pultruded stiffeners 60 may include welding one or more pultruded stiffeners to one or more of the internal surfaces 27, 29 of the blade segment 21.

For example, in certain embodiments, the step of welding one or more pultruded stiffeners 60 on one or more of the internal surfaces 27, 29 of the blade segment(s) 21 may include welding a base portion 62 of the pultruded stiffener 60 to the internal surface of the blade segment 21 such that a stiffening portion 64 of the pultruded stiffener 60 extends from the base portion 62 within an internal cavity 56 of the rotor blade 16 so as to resist a load through a thickness of the at least one blade segment 21. In addition, in another embodiment, the step of welding one or more pultruded stiffeners 60 to one or more of the internal surfaces 27, 29 of the blade segment(s) 21 may include welding one or more of the pultruded stiffeners 60 to one or more of the internal surfaces 27, 29 of the blade segment(s) 21 such that the stiffener 60 extends in a generally span-wise direction within the internal cavity 56 of the rotor blade.

In further embodiments, the method 100 may also include forming the pultruded stiffener(s) 60 so as to define a cross-section having one of the following shapes: triangle, rectangle, square, T-shaped, L-shaped, U-shaped, J-shaped, C-shaped, Z-shaped, V-shaped, or similar.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade for a wind turbine, comprising:
a main blade structure;
at least one blade segment configured with the main blade structure and defining an internal cavity of the rotor blade;
at least one spar cap configured within the internal cavity on an internal surface of the at least one blade segment; and,
at least one pultruded stiffener configured within the internal cavity of the at least one blade segment, the pultruded stiffener constructed, at least in part, from a thermoplastic resin system.

2. The rotor blade of claim 1, wherein the at least one blade segment is constructed, at least in part, from a thermoplastic resin system.

3. The rotor blade of claim 2, wherein the thermoplastic resin system of the pultruded stiffener or the blade segment further comprises at least one fiber reinforcement material, wherein the fiber reinforcement material comprises at least one of glass fibers, carbon fibers, polymer fibers, ceramic fibers, nanofibers, or metal fibers.

4. The rotor blade of claim 2, wherein the at least one pultruded stiffener is secured to the internal surface of the at least one blade segment via welding.

5. The rotor blade of claim 1, wherein the at least one pultruded stiffener is secured to the at least one spar cap.

6. The rotor blade of claim 1, further comprising opposing spar caps configured on opposing internal surfaces of the at least one blade segment and one or more shear webs configured between the opposing spar caps, wherein the at least one pultruded stiffener is secured to at least one of the opposing spar caps and the shear web.

7. The rotor blade of claim 1, wherein the pultruded stiffener comprises a base portion and a stiffening portion.

8. The rotor blade of claim 7, wherein the base portion is welded to the internal surface of the at least one blade segment such that the stiffening portion extends from the base portion within the internal cavity of the rotor blade so as to resist a load through a thickness of the at least one blade segment.

9. The rotor blade of claim 8, wherein the load comprises at least one of a buckling load, a flap-wise deflection, or an edge-wise deflection.

10. The rotor blade of claim 8, wherein the pultruded stiffener extends in a generally span-wise direction within the internal cavity of the rotor blade when configured within the internal cavity of the rotor blade.

11. The rotor blade of claim 1, wherein the pultruded stiffener defines a cross-section comprising one of the following shapes: triangle, rectangle, square, T-shaped, L-shaped, U-shaped, J-shaped, C-shaped, Z-shaped, or V-shaped.

12. A rotor blade for a wind turbine, comprising:
a blade root section;
a blade tip section;
a plurality of blade segments arranged between the blade root section and the blade tip section, each of the plurality of blade segments defining an internal cavity of the rotor blade and comprising a thickness defined by an internal surface and an external surface thereof;
opposing spar caps configured on opposing internal surfaces of the plurality of blade segments and extending in a generally span-wise direction;
one or more shear webs configured between the opposing spar caps; and,
at least one pultruded stiffener configured within the internal cavity of, the pultruded stiffener constructed, at least in part, from a thermoplastic resin system.

13. A method of improving stiffness of a rotor blade, the method comprising:
providing a rotor blade having a main blade structure and at least one blade segment, the blade segment defining an internal cavity; and,
locally reinforcing one or more locations of the blade segment with one or more pultruded stiffeners, the one or more pultruded stiffeners constructed, at least in part, from a thermoplastic resin system.

14. The method of claim 13, further comprising securing opposing spar caps on opposing internal surfaces of the at least one blade segment and securing one or more shear webs between the opposing spar caps.

15. The method of claim 14, wherein the one or more locations further comprises at least one of an internal surface of the at least one blade segment, at least one of the opposing spar caps, or the one or more shear webs.

16. The method of claim 13, further comprising forming the at least one blade segment, at least in part, from a thermoplastic resin system and at least one fiber reinforcement material.

17. The method of claim 13, wherein locally reinforcing the one or more locations on the internal surface of the blade segment with one or more pultruded stiffeners further comprises welding one or more pultruded stiffeners to the internal surface of the blade segment.

18. The method of claim 17, wherein welding one or more pultruded stiffeners to the internal surface of the blade segment further comprises welding a base portion of the pultruded stiffener to the internal surface of the blade segment such that a stiffening portion of the pultruded stiffener extends from the base portion within an internal cavity of the rotor blade so as to resist a load through a thickness of the at least one blade segment.

19. The method of claim 18, wherein welding one or more pultruded stiffeners to the internal surface of the blade segment further comprises welding one or more of the pultruded stiffeners to the internal surface of the blade segment such that the stiffener extends in a generally span-wise direction within the internal cavity of the rotor blade.

20. The method of claim 13, further comprising forming the pultruded stiffener so as to define a cross-section comprising one of the following shapes: triangle, rectangle, square, T-shaped, L-shaped, U-shaped, J-shaped, C-shaped, Z-shaped, or V-shaped.
